(19) United States
(12) Patent Application Publication
(10) Pub. No.: US 2011/0246476 A1
(43) Pub. Date: Oct. 6, 2011

(54) METHOD AND SYSTEM FOR PERFORMING A SEARCH OF A FEED IN AN ON-DEMAND ENTERPRISE SERVICES ENVIRONMENT

(75) Inventors: Walter Macklem, San Francisco, CA (US); Susan M. Kimberlin, San Francisco, CA (US); William A. Press, Berkeley, CA (US)

(73) Assignee: salesforce.com, Inc., San Francisco, CA (US)

(21) Appl. No.: 13/081,424

(22) Filed: Apr. 6, 2011

Related U.S. Application Data
(60) Provisional application No. 61/321,479, filed on Apr. 6, 2010.

(51) Int. Cl. G06F 17/30

(52) U.S. Cl. 707/741; 707/E17.002

(57) ABSTRACT

A method of searching in a database of feed items enables efficient searching through a large corpus of data. Each feed item is associated with at least one object in the database. An index of feed items is generated. For each feed item in the database, the index includes a body of the feed item and at least one foreign key that identifies an object associated with the feed item. A search request with one or more search terms is received from a first user. Using the index of feed items, a pre-filtered set of feed items is generated for the first user. The search is executed, using the index of feed items and the pre-filtered set of feed items. Search results are limited to feed items in the pre-filtered set of feed items.

### CROSS REFERENCE TO RELATED APPLICATIONS

The present application claims benefit under 35 USC 119(e) of U.S. provisional Application No. 61/321,479, filed on Apr. 6, 2010, entitled “METHOD AND SYSTEM FOR PERFORMING A SEARCH IN FEED OF AN ON-DEMAND ENTERPRISE SERVICES ENVIRONMENT,” the content of which is incorporated herein by reference in its entirety, and the following commonly owned, co-pending U.S. provisional application by Lee,. Application No. 61/260,653, filed Nov. 12, 2009 (Attorney Docket No. 021735-005900US) entitled “SYSTEMS AND METHODS FOR IMPLEMENTING ENTERPRISE LEVEL SOCIAL AND BUSINESS INFORMATION NETWORKING,” the content of which is incorporated herein by reference in its entirety. This application is related to co-pending and commonly-owned U.S. patent application Ser. No. 12/945,410, filed on Nov. 12, 2010, entitled “Enterprise Level Business Information Networking for Changes in a Database,” the disclosure of which is incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present invention relates generally to database systems, and more particularly to performing searches of feeds in an on-demand enterprise services environment.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Using present database systems, it may be difficult to search through huge data stores of feed items comprising posts, comments, and status updates. Due to the overwhelming quantities of data, search engines may, of necessity, truncate results using some arbitrary limitation, particularly when users search for common terms. Such arbitrary truncation, when performed in conjunction with additional filters based on user authorization and security, may result in extremely sparse or irrelevant search results.

Therefore it is desirable to provide systems and methods that overcome the above and other problems.

### BRIEF SUMMARY

The present invention provides systems, apparatus, and methods for performing a search in feeds in an on-demand enterprise services environment, e.g. feeds for enterprise level social and business information networking.

According to one aspect of the present invention, a method of searching in a database of feed items enables efficient searching through a large corpus of data. A database of feed items is provided, wherein each feed item in the database is associated with at least one object. An index of feed items is generated from the database of feed items, wherein, for each feed item in the database, the index includes a body of the feed item and at least one foreign key that identifies an object associated with the feed item. A first user is identified, wherein the first user is a user associated with a tenant of the multi-tenant database system. A search request is received, wherein the search request comprises one or more search terms. A search type is determined, wherein the search type comprises either subscribed feed items or authored feed items or a combination thereof, wherein the subscribed feed items comprise feed items associated with objects to which the first user has subscribed to receive feeds, and wherein the authored feed items comprise feed items authored by a designated user. Using the index of feed items, a pre-filtered set of feed items is generated for the first user, wherein feed items are filtered in accordance with the search type. The search for the one or more search terms is executed, using the index of feed items and the pre-filtered set of feed items, wherein the searching is limited to feed items in the pre-filtered set of feed items. Finally, zero or more search results are generated, wherein the search results consist of feed items from the pre-filtered set of feed items.

While the present invention is described with reference to an embodiment in which techniques for performing searches of feeds in an on-demand enterprise services environment are implemented in a system having an application server providing a front end for an on-demand database service capable of supporting multiple tenants, the present invention is not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 illustrates a block diagram of an example of an environment wherein an on-demand database service might be used.

FIG. 2 illustrates a block diagram of an embodiment of elements of FIG. 1 and various possible interconnections between these elements.

FIG. 3 is a flowchart of a method 400 for searching through feed items stored in a database system according to one or more embodiments.

FIG. 4 illustrates an example search interface according to one or more embodiments.

### DEFINITIONS

As used herein, the term “multi-tenant database system” refers to those systems in which various elements of hardware and software of the database system may be shared by one or more customers. For example, a given application server may simultaneously process requests for a great number of customers, and a given database table may store rows for a potentially much greater number of customers. As used herein, the term “query plan” refers to a set of steps used to access information in a database system.

As used herein, the term “user's profile” includes data about the user of the database system. The data can include general information, such as title, phone number, a photo, a biographical summary, and a status (e.g., text describing what the user is currently doing). As mentioned below, the data can include messages created by other users. Where there are multiple tenants, a user is typically associated with a particular tenant. For example, a user could be a salesperson of a company that is a tenant of the database system that provides a database service.

As used herein, the term “record” refers to an instance of a data object created by a user of the database service, for example, about a particular (actual or potential) business relationship or project. The data object can have a data structure defined by the database service (a standard object) or defined by a subscriber (custom object). For example, a record can be for a business partner or potential business partner (e.g. a client, vendor, distributor, etc.) of the user, and can include an entire company, subsidiaries, or contacts at the company. As another example, a record can be a project that the user is working on, such as an opportunity (e.g. a possible sale) with an existing partner, or a project that the user is trying to get. In one embodiment implementing a multi-tenant database, all of the records for the tenants have an identifier stored in a common table. A record has data fields that are defined by the structure of the object (e.g. fields of certain data types and purposes). A record can also have custom fields defined by a user. A field can be another record or include links thereto, thereby providing a parent-child relationship between the records.

As used herein, the term “feed” includes a combination (e.g. a list) of feed items. As user herein, the term “feed item” (or feed element) refers to information about a user (“profile feed”) of the database or about a record (“record feed”) in the database. A user following the user or record can receive the associated feed items. The feed items from all of the followed users and records can be combined into a single feed for the user.

As examples, a “feed item” can be a message and story (also called a feed tracked change). A feed can be a combination of messages and stories. Messages include text created by a user, and may include other data as well. Examples of messages include posts, status updates, and comments. Messages can be created for a user's profile or for a record. Posts can be created by various users, potentially any user, although some restrictions can be applied. As an example, posts can be made to a wall section of a user's profile (which can include a number of recent posts) or a section of a record that includes multiple posts. The posts can be organized in chronological order. In contrast to a post, a status update changes a status of a user and is made by that user. Other similar sections of a user's profile can also include an “About” section. A record can also have a status, whose update can be restricted to the owner of the record. The owner can be a single user, multiple users, or a group. In one embodiment, there is only one status for a record. In one embodiment, a comment can be made on any feed item. In another embodiment, comments are organized as a list explicitly tied to a particular story, post, or status update. In this embodiment, comments may not be listed in the first layer (in a hierarchal sense) of feed items, but listed as a second layer branching from a particular first layer feed item.

A “story” is data representing an event, and can include text generated by the database system in response to the event. In one embodiment, the data can initially be stored, and then the database system can later use the data to create text for describing the event. Both the data and/or the text can be a story, as used herein. In various embodiments, an event can be an update of a record and/or can be triggered by a specific action by a user. Which actions trigger an event can be configurable. Which events have stories created and which stories are sent to which users can also be configurable. Messages and stories can be stored as a field or child object of the record. For example, the feed can be stored as a child object of the record.

As used herein, a “group” is a collection of users. In some aspects, the group may be defined as users with a same or similar attribute, or by membership. In one embodiment, a “group feed” includes any feed item about any user in a group. In another embodiment, a “group feed” includes feed items that are about the group as a whole. In one implementation, the feed items for a group are only posts and comments.

As used herein, an “entity feed” or “record feed” refers to a feed of feed items about a particular record in the database, such as stories about changes to the record and posts made by users about the record. An entity feed can be composed of any type of feed item. Such a feed can be displayed on a page (e.g. a web page) associated with the record (e.g. a home page of the record). As used herein, a “profile feed” is a feed of feed items about a particular user. In one embodiment, the feed items for a profile feed are posts and comments that other users make about or send to the particular user, and status updates made by the user. Such a profile feed can be displayed on a page associated with the particular user. In another embodiment, feed items in a profile feed could include posts made by the particular user and feed tracked changes (stories) initiated based on actions of the particular user.

### DETAILED DESCRIPTION

### General Overview

Systems, apparatus, and methods are provided for implementing enterprise level social and business information networking Such embodiments can provide more efficient use of a database system. For instance, a user of a database system may not easily know when important information in the database has changed, e.g., about a project or client. Embodiments can provide stories about such changes and other events, thereby keeping users informed.

By way of example, a user can update a record (e.g. an opportunity such as a possible sale of 1000 computers). Once the update has been made, a story about the update can then automatically be sent (e.g. in a feed) to anyone subscribing to the opportunity or to the user. Thus, the user does not need to contact a manager regarding the change in the opportunity, since the story about the update is sent via a feed right to the manager's feed page (or other page).

Next, mechanisms and methods for providing systems and methods for implementing enterprise level social and business information networking will be described with reference to example embodiments. First, an overview of an example database system is described, and then examples of tracking events for a record, actions of a user, and messages about a user or record are described. Various embodiments about the data structure of feeds, customizing feeds, user selection of records and users to follow, generating feeds, and displaying feeds are also described.

### II. System Overview

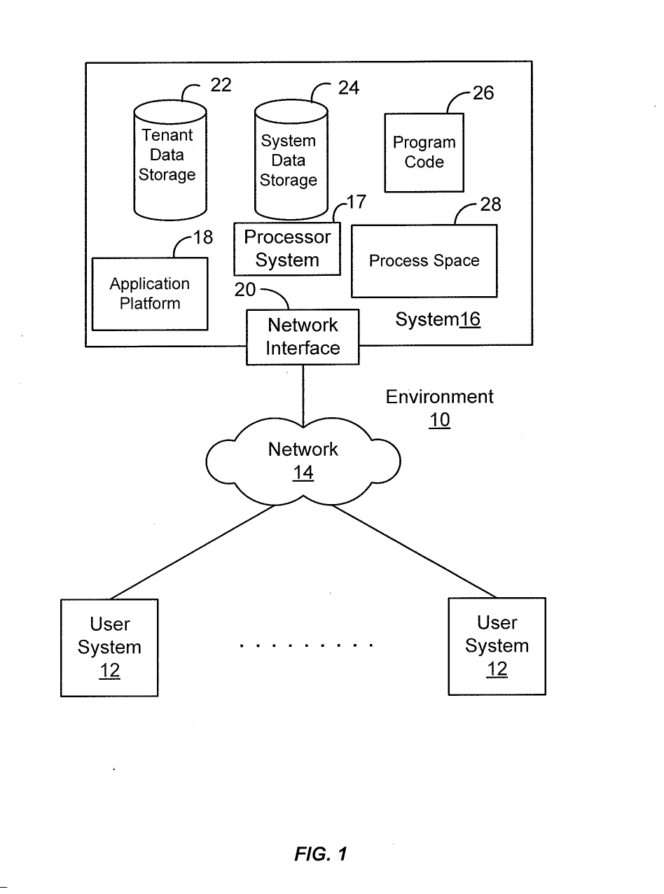

FIG. 1 illustrates a block diagram of an environment 10 wherein an on-demand database service might be used. Environment 10 may include user systems 12, network 14, system 16, processor system 17, application platform 18, network interface 20, tenant data storage 22, system data storage 24, program code 26, and process space 28. In other embodiments, environment 10 may not have all of the components listed and/or may have other elements instead of, or in addition to, those listed above.

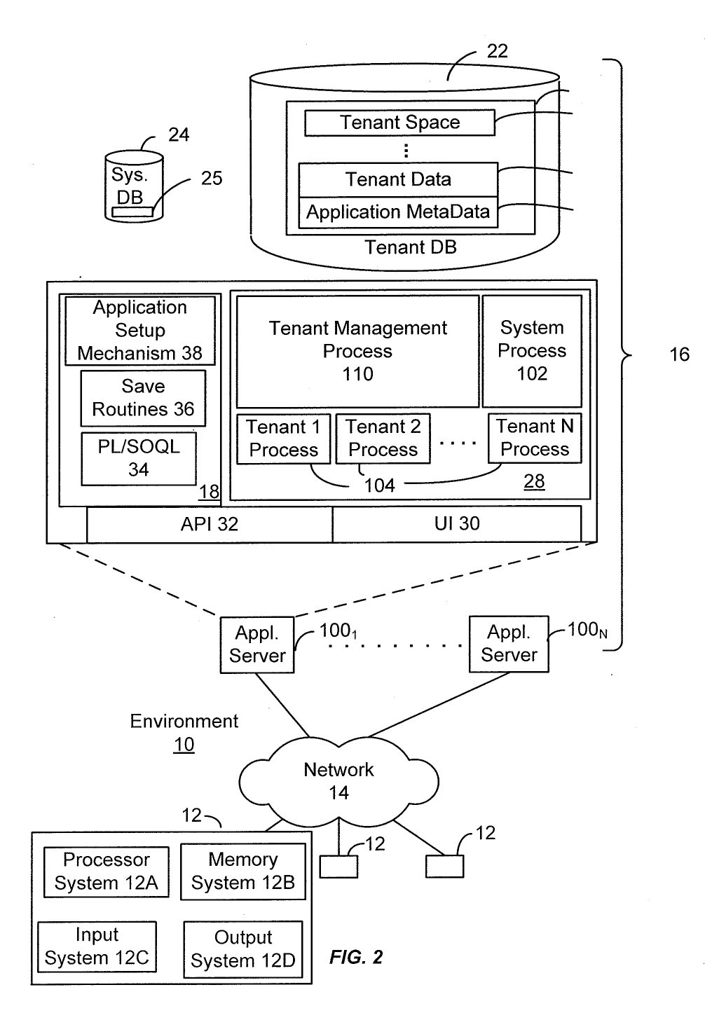

Environment 10 is an environment in which an on-demand database service exists. User system 12 may be any machine or system that is used by a user to access a database user system. For example, any of user systems 12 can be a handheld computing device, a mobile phone, a laptop computer, a work station, and/or a network of computing devices. As illustrated in FIG. 1 (and in more detail in FIG. 2) user systems 12 might interact via a network 14 with an on-demand database service, which is system 16.

An on-demand database service, such as system 16, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 16” and “system 16” will be used interchangeably herein. A database image may include one or more database objects. A relational database management system (RDMS) or the equivalent may execute storage and retrieval of information against the database object(s). Application platform 18 may be a framework that allows the applications of system 16 to run, such as the hardware and/or software, e.g., the operating system. In an embodiment, on-demand database service 16 may include an application platform 18 that enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, where a salesperson is using a particular user system 12 to interact with system 16, that user system has the capacities allotted to that salesperson. However, while an administrator is using that user system to interact with system 16, that user system has the capacities allotted to that administrator. In systems with a hierarchical role model, users at one permission level (profile type) may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that embodiments might be use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP messages to and from an HTTP server at system 16. Such an HTTP server might be implemented as the sole network interface between system 16 and network 14, but other techniques might be used as well or instead. In some implementations, the interface between system 16 and network 14 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 16, shown in FIG. 1, implements a web-based customer relationship management (CRM) system. For example, in one embodiment, system 16 includes application servers configured to implement and execute CRM software applications as well as provide related data, code, forms, webpages and other information to and from user systems 12 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIG. 1, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 1 include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 12 and all of its components are operator configurable using applications, such as a browser, including computer code run using a central processing unit such as an Intel Pentium® processor or the like. Similarly, system 16 (and additional instances of an MTS, where more than one is present) and all of their components might be operator configurable using application(s) including computer code to run using a central processing unit such as processor system 17, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 16 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 16 is configured to provide webpages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2 also illustrates environment 10. However, in FIG. 2 elements of system 16 and various interconnections in an embodiment are further illustrated. FIG. 2 shows that user system 12 may include processor system 12A, memory system 12B, input system 12C, and output system 12D. FIG. 2 shows network 14 and system 16. FIG. 2 also shows that system 16 may include tenant data storage 22, tenant data 23, system data storage 24, system data 25, User Interface (UI) 30, Application Program Interface (API) 32, PL/SOQL 34, save routines 36, application setup mechanism 38, applications servers 100₁-100_{N}, system process space 102, tenant process spaces 104, tenant management process space 110, tenant storage area 112, user storage 114, and application metadata 116. In other embodiments, environment 10 may not have the same elements as those listed above and/or may have other elements instead of, or in addition to, those listed above.

User system 12, network 14, system 16, tenant data storage 22, and system data storage 24 were discussed above in FIG. 1. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 2, system 16 may include a network interface 20 (of FIG. 1) implemented as a set of HTTP application servers 100, an application platform 18, tenant data storage 22, and system data storage 24. Also shown is system process space 102, including individual tenant process spaces 104 and a tenant management process space 110. Each application server 100 may be configured to tenant data storage 22 and the tenant data 23 therein, and system data storage 24 and the system data 25 therein to serve requests of user systems 12. The tenant data 23 might be divided into individual tenant storage areas 112, which can be either a physical arrangement and/or a logical arrangement of data. Within each tenant storage area 112, user storage 114 and application metadata 116 might be similarly allocated for each user. For example, a copy of a user's most recently used (MRU) items might be stored to user storage 114. Similarly, a copy of MRU items for an entire organization that is a tenant might be stored to tenant storage area 112. A UI 30 provides a user interface and an API 32 provides an application programmer interface to system 16 resident processes to users and/or developers at user systems 12. The tenant data and the system data may be stored in various databases, such as one or more Oracle™ databases.

Application platform 18 includes an application setup mechanism 38 that supports application developers' creation and management of applications, which may be saved as metadata into tenant data storage 22 by save routines 36 for execution by subscribers as one or more tenant process spaces 104 managed by tenant management process 110 for example. Invocations to such applications may be coded using PL/SOQL 34 that provides a programming language style interface extension to API 32. A detailed description of some PL/SOQL language embodiments is discussed in commonly owned U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is incorporated in its entirety herein for all purposes. Invocations to applications may be detected by one or more system processes, which manages retrieving application metadata 116 for the subscriber making the invocation and executing the metadata as an application in a virtual machine.

Each application server 100 may be communicably coupled to database systems, e.g., having access to system data 25 and tenant data 23, via a different network connection. For example, one application server 100₁ might be coupled via the network 14 (e.g., the Internet), another application server 100_{N-1} might be coupled via a direct network link, and another application server 100_{N} might be coupled by yet a different network connection. Transfer Control Protocol and Internet Protocol (TCP/IP) are typical protocols for communicating between application servers 100 and the database system. However, it will be apparent to one skilled in the art that other transport protocols may be used to optimize the system depending on the network interconnect used.

In certain embodiments, each application server 100 is configured to handle requests for any user associated with any organization that is a tenant. Because it is desirable to be able to add and remove application servers from the server pool at any time for any reason, there is preferably no server affinity for a user and/or organization to a specific application server 100. In one embodiment, therefore, an interface system implementing a load balancing function (e.g., an F5 Big-IP load balancer) is communicably coupled between the application servers 100 and the user systems 12 to distribute requests to the application servers 100. In one embodiment, the load balancer uses a least connections algorithm to route user requests to the application servers 100. Other examples of load balancing algorithms, such as round robin and observed response time, also can be used. For example, in certain embodiments, three consecutive requests from the same user could hit three different application servers 100, and three requests from different users could hit the same application server 100. In this manner, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain embodiments, user systems 12 (which may be client systems) communicate with application servers 100 to request and update system-level and tenant-level data from system 16 that may require sending one or more queries to tenant data storage 22 and/or system data storage 24. System 16 (e.g., an application server 100 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to the present embodiments. It should be understood that “table” and “object type” may be used interchangeably herein. Each table generally contains one or more data categories logically arranged as columns or fields in a viewable schema. Each row or record of a table contains an instance of data for each category (type) defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, Opportunity data, and other object types, each containing pre-defined fields. It should be understood that the word “entity” may also be used interchangeably herein with “object” and “table”, when entity or object is referring to a collection of objects or entities of a particular type.

In some multi-tenant database systems, tenants may be allowed to create and store custom objects, or they may be allowed to customize standard entities or objects, for example by creating custom fields for standard objects, including custom index fields. U.S. Pat. No. 7,779,039, entitled “Custom Entities and Fields in a Multi-Tenant Database System”, by Craig Weissman, filed Apr. 2, 2004, which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

### Searching Feed Items

Databases of feed items may have very large data volumes, which presents scalability issues on several fronts—one of these providing search functionality that operates as a user would expect. Given a large corpus of feed items, querying for common words will likely result in an enormous number of hits. Even querying for uncommon words will possibly result in a large number of hits. One solution to this problem is to implement pre-filtering methodologies in order to reduce the large corpus prior to performing the actual search—this can be accomplished without losing meaningful search results when the pre-filtering methodologies are tailored to the user.

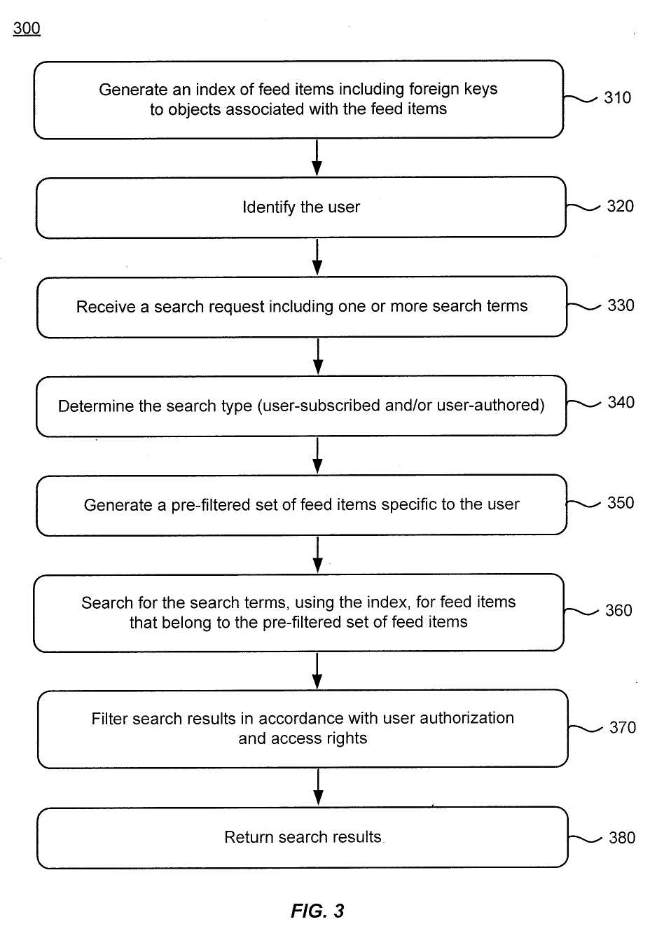

FIG. 3 is a flowchart of a method 300 for searching through feed items in a database system according to embodiments. In some embodiments, method 300 (and other methods described herein) may be implemented at least partially with multi-tenant database system 16, e.g., by one or more processors configured to receive or retrieve information, process the information, store results, and the transmit the results. In other embodiments, method 300 may be implemented at least partially with a single tenant database system. In various embodiments, steps may be omitted, combined, or split into additional steps for method 300, as well as for other methods described herein.

In step 310, an index of feed items is generated. This index may include any number of fields from a table storing feed items; preferably, the index includes at least a unique ID for each feed item, the body of the feed item, and at least one foreign key field for the feed item. In some embodiments, only feed items that comprise messages entered by humans are included (thereby excluding feed items that are auto-generated, e.g., status updates to reflect changes made to records). In some embodiments, only feed items that comprise feed posts and feed comments are included. In some embodiments, the index may also include fields for the author of the feed item, a title or subject of the feed item, or other metadata, such as user-assigned tags or categorization, or automatically-computed context tags. In some embodiments, the index may also include a story.

In some embodiments, a foreign key for the feed item comprises a reference to an object (e.g., object ID), wherein the object is the topic of the feed item (e.g., for an entity feed, a reference to the entity, or, for a profile feed, a reference to the user whose profile is the subject of the profile feed). In some embodiments, a foreign key for a feed comment is a reference to the original feed post to which the feed comment is responsive. In some embodiments, a foreign key field may include one or more foreign keys.

In some embodiments, a foreign key for the feed item comprises a reference to the author of the feed item. In some embodiments, a foreign key for a feed comment includes a reference to the author of the original feed post to which the feed comment is responsive.

In step 320, the designated user for whom the search will be performed is identified. In one embodiment, the designated user may be actively entering data via a user interface, such as a web page. In other embodiments, operations may be executed on behalf of a user. In one example embodiment, the designated user saved a search to be performed periodically at pre-designated intervals. In another embodiment, an administrator, e.g., customer service agent, may perform the search on behalf of the designated user. In another embodiment, the search request may be generated on behalf of the designated user via an API call from another program.

In one embodiment, once the designated user has been identified, the system looks up the user's subscriptions. The user's subscriptions may include those objects (e.g., users or entities) that the user is following. Co-pending commonly-owned U.S. patent application Ser. No. 12/945,410, entitled “Enterprise Level Business Information Networking for Changes in a Database,” the disclosure of which is incorporated by reference in its entirety, includes further detail on subscriptions to feeds.

In step 330, a search request is received. In one embodiment, a user or administrator may directly enter search terms and search parameters into a user interface, e.g., a web page. In another embodiment, the database system automatically generates the search request. In another embodiment, the search request is submitted via an API call from another software program.

In some embodiments, the search request includes one or more search terms. In some embodiments, the search request may include one or more search parameters, such as a search type. The search type may limit the search to certain types of feeds, e.g., the user's newsfeed, the user's profile feed, or some other particular type of entity feed. In some embodiments, other search parameters may include any conventional search parameter, e.g., maximum number of search results, number of search results displayed per page, method of ordering search results.

In step 340, the search type is determined. The search type limits the search to a particular type of feed item; in some embodiments, the search type defaults to be all-inclusive. In some embodiments, a user-authored search type includes feed items authored by the user. In some embodiments, a user-subscribed search type includes feed items associated with objects (e.g., users or entities) that the user is following. In some embodiments, a user-subscribed search type may also designate a particular object or category of objects. In some embodiments, the user may be able to select a combination search type; this combination search type may be based upon an inclusive or exclusive OR.

In step 350, a pre-filtered set of feed items is generated—this pre-filtered set of feed items may be specific to the user and the search type. For example, for a user-authored search type, the pre-filtered set of feed items may include only those feed items authored by the user. In another example, for a user-subscribed search type that designates only Lead objects, the pre-filtered set of feed items may include only those feed items on the topic of those Lead objects that the user is following.

In one embodiment, the pre-filtered set of feed items is generated using the index of feed items. In one embodiment, the pre-filtered set of feed items is renewed for each search request submitted by or on behalf of the user, in order to capture feed items submitted since the last search by or on behalf of the user. In one embodiment, for particular types of batch processes involving repetitive searches, the pre-filtered set of feed items may be temporarily stored in order to reduce latency.

In some embodiments, the feed items selected for inclusion in the pre-filtered set of feed items includes those feed items identified as falling within a specified search type. For example, for a user-authored search type, selected feed items may include those authored by the user. In another example, for a user-subscribed search type, selected feed items may include those associated with objects for which the user has subscribed to feeds. In one embodiment, when a feed post is selected for inclusion in the pre-filtered set of feed items, all associated feed comments are likewise included, and vice versa.

In step 360, the search is executed. In some embodiments, the system searches through all fields in the index for the search terms; in other embodiments, the system searches only through designated fields, e.g., body and/or title. In one embodiment, the system searches for the search terms using the index of feed items and checks any hits against the pre-filtered set of feed items. In one embodiment, the system searches directly against the pre-filtered set of feed items. In one embodiment, search results may be truncated at some pre-determined limit (e.g., 20,000), so as not to overwhelm the system. In one embodiment, when a feed post is included in the search results, all associated feed comments are likewise included, and vice versa.

In step 370, the search results may be filtered in accordance with the user's authorization and access rights. For example, the search results may be limited to those feed items associated with objects for which the user has access (e.g., the tenant associated with the user and other Contacts and Leads with whom the user has an established relationship).

In step 380, the search results are returned. In one embodiment, all of the search results are returned at once. In one embodiment, only a designated chunk of the search results may be returned (e.g., search results numbered 101-150); the original search request may have included a search parameter designating which chunk of search results to return.

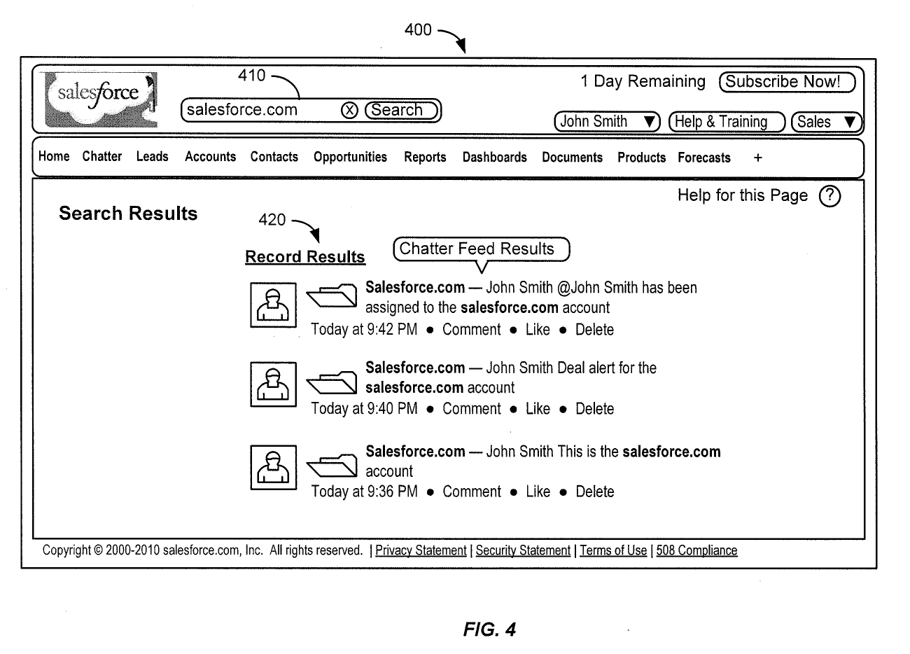

FIG. 4 illustrates an example search interface according to one or more embodiments. Web page 400 illustrates a search for search term “salesforce.com,” as shown in text field 410, performed by or on behalf of John Smith. As can be seen in the listing of search results 420, the search results include only those feed items including search term “salesforce.com” that are associated with the salesforce.com Account entity object, to which John Smith has subscribed.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

It should be understood that any of the embodiments of the present invention can be implemented in the form of control logic using hardware and/or using computer software in a modular or integrated manner. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer program product (e.g. a hard drive or an entire computer system), and may be present on or within different computer program products within a system or network. A computer system may include a monitor, printer, or other suitable display for providing any of the results mentioned herein to a user.

Any of the methods described herein may be totally or partially performed with a computer system including a processor, which can be configured to perform the steps. Thus, embodiments can be directed to computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, any of the steps of any of the methods can be performed with modules, circuits, or other means for performing these steps.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

What is claimed is:

1. A method of searching in a database of feed items, the method comprising:
providing a database of feed items, wherein the database is stored on one or more servers associated with a multi-tenant database system, wherein each feed item in the database is associated with at least one object;
generating, using one or more processors associated with the one or more servers, an index of feed items from the database of feed items, wherein, for each feed item in the database, the index includes a body of the feed item and at least one foreign key that identifies an object associated with the feed item;
identifying a first user, wherein the first user is a user associated with a tenant of the multi-tenant database system;
receiving a search request, wherein the search request comprises one or more search terms;
determining a search type, wherein the search type comprises either subscribed feed items or authored feed items or a combination thereof, wherein the subscribed feed items comprise feed items associated with objects to which the first user has subscribed to receive feeds, and wherein the authored feed items comprise feed items authored by a designated user;
generating, using the index of feed items, a pre-filtered set of feed items for the first user, wherein feed items are filtered in accordance with the search type;
searching, using the index of feed items and the pre-filtered set of feed items, for the one or more search terms, wherein the searching is limited to feed items in the pre-filtered set of feed items; and
generating zero or more search results, wherein the search results consist of feed items from the pre-filtered set of feed items.

2. The method of claim 1, wherein a feed item comprises a feed post, feed comment, or a story.

3. The method of claim 1, wherein the search type includes authored feed items, and wherein generating the pre-filtered set of feed items further comprises:
identifying, using the index of feed items, feed items authored by the designated user; and
adding the identified feed items to the pre-filtered set of feed items.

4. The method of claim 1, wherein the authored feed items comprise feed items authored by the first user.

5. The method of claim 1, wherein the search type includes subscribed feed items, further comprising:
retrieving one or more subscriptions for the first user, wherein each retrieved subscription identifies an object to which the first user has subscribed to receive feed items;
identifying, using the index of feed items, feed items associated with objects for which the first user has subscribed to receive feed items; and
adding the identified feed items to the pre-filtered set of feed items.

6. The method of claim 1, wherein searching for the one or more search terms comprises searching for the one or more search terms in the body of a feed item.

7. The method of claim 1, wherein the search request comprises the search type, and wherein determining the search type comprises retrieving a submitted search type from the search request.

8. The method of claim 1, further comprising:
excluding feed items from the set of search results, wherein the subscriber is not authorized to view the excluded feed items.

9. A computer program product comprising a computer-readable medium storing a plurality of instructions for searching through feed items stored in a multi-tenant database system, the instructions comprising:
program code to generate, using one or more processors associated with one or more servers, an index of feed items, wherein each feed item is associated with at least one object of a multi-tenant database system, and wherein, for each feed item, the index comprises a body of the feed item and at least one foreign key that identifies an object associated with the feed item;
program code to identify a first user, wherein the first user is a user associated with a tenant of the multi-tenant database system;
program code to receive a search request, wherein the search request comprises one or more search terms;
program code to determine a search type, wherein the search type comprises either subscribed feed items or authored feed items or a combination thereof, wherein the subscribed feed items comprise feed items associated with objects to which the first user has subscribed to receive feeds, and wherein the authored feed items comprise feed items authored by a designated user;
program code to generate, using the index of feed items, a pre-filtered set of feed items for the first user, wherein feed items are filtered in accordance with the search type;
program code to search, using the index of feed items and the pre-filtered set of feed items, for the one or more search terms, wherein the searching is limited to feed items in the pre-filtered set of feed items; and
program code to generate zero or more search results, wherein the search results consist of feed items from the pre-filtered set of feed items.

10. The computer program product of claim 9, wherein a feed item comprises a feed post, feed comment, or a story.

11. The computer program product of claim 9, wherein the search type includes authored feed items, and wherein the instruction comprising program code to generate the pre-filtered set of feed items further comprises:
program code to identify, using the index of feed items, feed items authored by the designated user; and
program code to add the identified feed items to the pre-filtered set of feed items.

12. The computer program product of claim 9, wherein the authored feed items comprise feed items authored by the first user.

13. The computer program product of claim 9, wherein the search type includes subscribed feed items, the instructions further comprising:
program code to retrieve one or more subscriptions for the first user, wherein each retrieved subscription identifies an object to which the first user has subscribed to receive feed items;
program code to identify, using the index of feed items, feed items associated with objects for which the first user has subscribed to receive feed items; and
program code to add the identified feed items to the pre-filtered set of feed items.

14. The computer program product of claim 9, wherein the instruction comprising program code to search for the one or more search terms comprises program code to search for the one or more search terms in the body of a feed item.

15. The computer program product of claim 9, wherein the search request comprises the search type, and wherein determining the search type comprises retrieving a submitted search type from the search request.

16. The computer program product of claim 9, the instructions further comprising:
program code to exclude feed items from the set of search results, wherein the subscriber is not authorized to view the excluded feed items.

17. A multi-tenant database system comprising:
a database of feed items, wherein the database is stored on one or more servers associated with a multi-tenant database system; and
one or more processors associated with the multi-tenant database system, wherein the one or more processors are configured to perform the following operations:
generate, using one or more processors associated with one or more servers, an index of feed items, wherein each feed item is associated with at least one object of a multi-tenant database system, and wherein, for each feed item, the index comprises a body of the feed item and at least one foreign key that identifies an object associated with the feed item;
identify a first user, wherein the first user is a user associated with a tenant of the multi-tenant database system;
receive a search request, wherein the search request comprises one or more search terms;
determine a search type, wherein the search type comprises either subscribed feed items or authored feed items or a combination thereof, wherein the subscribed feed items comprise feed items associated with objects to which the first user has subscribed to receive feeds, and wherein the authored feed items comprise feed items authored by a designated user;
generate, using the index of feed items, a pre-filtered set of feed items for the first user, wherein feed items are filtered in accordance with the search type;
search, using the index of feed items and the pre-filtered set of feed items, for the one or more search terms, wherein the searching is limited to feed items in the pre-filtered set of feed items; and
generate zero or more search results, wherein the search results consist of feed items from the pre-filtered set of feed items.

18. The multi-tenant database system of claim 17, wherein the search type includes authored feed items, and wherein the one or more processors are configured to perform further operations to:
identify, using the index of feed items, feed items authored by the designated user; and
add the identified feed items to the pre-filtered set of feed items.

19. The multi-tenant database system of claim 17, wherein the authored feed items comprise feed items authored by the first user.

20. The multi-tenant database system of claim 17, wherein the search type includes subscribed feed items, and wherein the one or more processors are configured to perform further operations to:
retrieve one or more subscriptions for the first user, wherein each retrieved subscription identifies an object to which the first user has subscribed to receive feed items;
identify, using the index of feed items, feed items associated with objects for which the first user has subscribed to receive feed items; and
add the identified feed items to the pre-filtered set of feed items.

21. The multi-tenant database system of claim 17, wherein the one or more processors are configured to perform further operations to:
exclude feed items from the set of search results, wherein the subscriber is not authorized to view the excluded feed items.
